(19) United States
(12) Patent Application Publication
(10) Pub. No.: US 2005/0255148 A1
(43) Pub. Date: Nov. 17, 2005

(54) Treat for administering medication to animals or pets

(76) Inventor: Robert W. Puma, Indianapolis, IN (US)

Correspondence Address: Bose McKinney & Evans LLP;Intellectual Property Group, 2700 First Indiana Plaza, 135 North Pennsylvania Street, Indianapolis, IN, 46204, US

(21) Appl. No.: 11/131,169

(22) Filed: May 17, 2005

Related U.S. Application Data
(60) Provisional application No. 60/571,870, filed on May 17, 2004.

(51) Int. Cl. A23K 1/165

(52) U.S. Cl. 424/442

(57) ABSTRACT

The present invention concerns a treat for administering medication to an animal or pet. The treat includes a cooked edible structure having an outer surface and an inner surface. The outer surface of the edible structure is connected to the inner surface by a joining surface. The joining surface defines an opening extending between the outer surface and the inner surface. The inner surface defines an interior volume or pouch. The opening is sized to receive an animal or pet medication. The animal or pet medication is received within an interior bed. The medication and the interior bed substantially fill the pouch. The interior bed preferably includes one or more animal digestible materials having adhesive properties for retaining the medication in the pouch. The treat may include one or more openings, and the openings may be of different sizes and/or sized to snugly fit as mediation is inserted therethrough.

This application claims the benefit of U.S. Provisional Application Ser. No. 60/571,870 filed on May 17, 2004.

### BACKGROUND OF THE INVENTION

As known to those of skill in the art, numerous problems may be encountered during the administration of medication to animals or pets. For example, in one method of administering medication to animals, the animal or pet owner holds the mouth or jaw of the animal open, forces the medication in the mouth, and then massages the throat trying to make the animal swallow the pill or liquid medication. This method may or may not be successful based on the willingness and/or intelligence of the animal. The animal may eat the medication and/or hide it in its mouth. The animal then may, without the animal or pet owner's awareness, spit the medication out. Thus, the animal or pet owner remains unsure whether or not the medication was actually ingested. Moreover, when the medication is in a liquid form, the animal may spit out the medication directly from the beginning.

Other methods are also known to those of skill in the art. One such method involves the use of a tube by the owner of the pet or animal. Medication is placed in a tube, the tube (and consequently the medication) then being inserted into the back of the animal's mouth. This method presents difficulties for the animal or pet owner as they are required to insert medication into each tube, place the tube at a certain angle so the animal may ingest the medication, and hope the animal or pet takes the medication. This method is time consuming for the owner, requires a great degree of skill, and is not pet-friendly to the animal.

Animal or pet medication has also been administered by attempting to hide the medication in a type of food (such as cheese or meat). This mechanism has also proven unsatisfactory. Reasons for the failure of this approach may include situations where the animal eats the entire treat or food given except the medication up front, or hides the medication in their mouth and then spits it out when unobserved by the animal or pet owner. Alternatively, the animal may eat everything but the medication directly in front of the animal or pet owner. Moreover, even when medication is effectively administered using a carrier of meat and/or cheese or animal food, such carriers may be unhealthy for animals to consume on a regular basis. Studies show that animals or pets that are overweight have a lifespan reduced by approximately 15% when compared to animals with a healthy weight. Based on the life expectancy of the animal, this can amount to 2-4 years. Thus, animals would preferably have a healthy alternative to taking their medication without significantly impacting their weight or lifespan.

The above identified approaches can be stressful and hinder the relationship between the animal and its owner. Failed attempts at administration of the medication are also a loss of dollars spent on medication. Thus, owners are losing money wasted on medication not fully consumed, as well as experiencing frustration based on the animal or pet's failure to fully consume the medication. Studies also show that 30% to 40% of animal or pet owners do not finish the full course of treatment with the medication because humans are always trying to find different ways of giving pets medication. Thus, an improved mechanism for administration of medication also increases pet or animal owner compliance with the veterinarian's instructions. The present invention is an improved mechanism for the administration of medication to animals.

### SUMMARY OF THE INVENTION

In one embodiment of the present invention there is a treat for administering medication to an animal or pet. The treat includes an edible structure having an outer surface and an inner surface. The outer surface of the edible structure is connected to the inner surface by a joining surface. The joining surface defines an opening extending between the outer surface and the inner surface. The inner surface defines an interior volume or pouch. The opening is sized to receive animal or pet medication. Based on the amount of medication the pet or animal may receive, there may be numerous beds where the medication may be inserted. The animal or pet medication is received with an interior bed. The medication and the interior bed substantially fill the pouch. The interior bed includes one or more animal digestible materials having adhesive properties for retaining the medication in the area.

In another embodiment of the present invention there is disclosed a treat for administering medication to an animal or pet. The treat comprises an at least partially hollow edible baked material extending between a first end and a second end. The baked material includes at least a first opening at the first end and a second opening at the second end. The first opening is connected to the second opening by the inner surface of the baked material. The inner surface of the baked material defines an internal compartment therein. The treat further comprises an interior bed positioned substantially within the internal compartment. The interior bed includes one or more edible ingredients having adhesive properties for retaining the medication at least partially within the internal compartment.

In another embodiment of the present invention there is an animal or pet treat for administering medication. The treat comprises an edible substantially rigid baked dough. The baked dough has a wall with an exterior surface and an interior surface extending between a first end and a second end. The second end of the exterior surface defines at least one opening connecting the interior surface and the exterior surface. The treat further comprises a sticky edible material that at least partially fills a pouch within the treat. The pouch is defined by the interior surface of the wall.

In another embodiment of the present invention there is a treat for administering medication to an animal or pet. The treat comprises an at least partially hollow edible material having an exterior surface and an interior surface. The exterior surface defines at least two separate openings through which a pocket defined by the interior surface can be accessed. At least two of the openings are of different sizes. The treat further comprises an interior bed positioned within the pocket. The interior bed includes one or more edible ingredients having adhesive properties for retaining the medication at least partially within the pocket.

### BRIEF DESCRIPTION OF THE DRAWINGS

FIG. 1 is a perspective view of one embodiment of the present invention.

FIG. 2 is a side view of the embodiment of FIG. 1.

FIG. 3 is an cross sectional view of the embodiment of FIG. 2 along the lines 3-3.

FIG. 4 is a side view of another embodiment having two openings.

FIG. 5 is a perspective view of an embodiment of a bottom tray for forming one embodiment of a treat.

FIG. 6 is a perspective view of an embodiment of a top tray corresponding to the bottom tray of FIG. 5, for forming one embodiment of a treat.

### DETAILED DESCRIPTION OF THE PREFERRED EMBODIMENTS

In the present invention the mechanism for administering medication comprises a consumable treat for an animal or pet. It is understood that the term animal or pet encompasses dogs, cats, cattle, donkeys, monkeys, chinchillas, birds, horses, cows, pigs, rabbits, rodents, reptiles or any other animal seen as needing or having difficulty taking medication. It is further understood that the material of the treat and its size may vary based on the particular animal or pet.

In one embodiment of the present invention the consumable treat preferably comprises an animal or pet food product that may include a hard and/or crunchy exterior and a soft, smooth interior in which the medication adheres to the interior and/or a filler substance or material therein. It should be understood that the animal medication may take any of a variety of forms. Such forms include pill, liquid or any other type that might be available from animal drug and/or vitamin companies.

In another embodiment of the present invention the consumable treat preferably comprises an exterior that may or may not be rigid. The surface of the exterior preferably defines an opening at one end that provides access to the interior. It should be understood that it is contemplated as within the scope of the invention that in various embodiments of the present invention the exterior might define more than one opening. The interior of the treat is preferably at least partially filled by one or more edible materials to which the medication may adhere. It should be understood that it is contemplated as within the scope of the invention that the pouch of the treat could also be completely filled with such materials. Thus, the preferably “sticky” material of the interior will reduce and/or minimize the crumbs and/or other litter normally associated with administering medication via a consumable substance. Moreover, the preferably crunchy exterior combined with the at least partially filled (and preferably substantially smooth) interior assists in inducing the animal to bite through the pill and/or masks the presence of a medication, particularly a liquid medication.

Various embodiments of the present invention include a (preferably, but not necessarily, substantially crunchy) exterior and a (preferably substantially smooth) interior with an opening defined in the outer surface to connect the exterior to the interior. Embodiments including a single opening reduce the likelihood of the medication becoming separated from the remainder of the consumable treat as it is chewed and/or ingested by the animal or pet. Additionally, it is contemplated as within the scope of the invention that embodiments including more than one opening may include openings of different sizes. Depending on the size of the medication, an opening could be selected to snugly retain a medication of that size.

It is also contemplated as within the scope of the invention that the exterior of the treat may be curved or flat or some combination of the two. It should be understood that in one preferred embodiment the treat has an opening on one end and is closed at the other end. Embodiments with a single opening at only one end permit the animal or pet owner to apply the medication to the interior of the treat with a reduced possibility of the pill or liquid medication escaping the treat prior to consumption. It should be understood that an embodiment with openings at both ends is contemplated as within the scope of the invention.

It will be understood by those of ordinary skill in the art that a wide variety of ingredients are contemplated as within the scope of the present invention. In various preferred embodiments of the present invention the ingredients may include, but are not limited to, one or more, or some combination, of the ingredients discussed in the remainder of this paragraph. Among the potential ingredients are various flours and other cooking ingredients including, but not limited to: soy flour, wheat flour, rice, brown rice, rice flour, willard water, water, salt, sugar, butter, eggs, corn, corn flour, dried egg powder, animal fat (including, but not limited to, chicken fat, turkey fat, or various other fats), vegetable oil, calcium carbonate, potassium chloride, sodium chloride, taurine, ground barley, brewers yeast, corn meal, sorbie acid, bran, wheat starch, wheat gluten, oats (particularly rolled oats), spelt flour, molasses, milk, honey, hydronated starch, corn syrup, corn grits, sunflower oil, milk, milk powder, pepper, rye, rye flour, bean flour, amaranth flour, and barley flour. Other potential ingredients (in addition to the possibility of using the just described ingredients) are preferably used for the filler or other material in the pouch or internal compartment of the consumable treat, but could also be part of the structure of the treat. Such ingredients include various meats (including by product meals) such as chicken, beef or pork in the form of dried beef, beef hide, beef broth, beef tallow, liver, veal, sausage, bologna, bacon, ham, pepperoni, turkey, duck, goose, and other birds. Such ingredients could also include fish products such as fish oil, fish meal (including, but not limited to, catfish meal), fish broth, tuna, cod, shrimp, salmon, crab, lobster, halibut, whitefish, pollack, clam, oyster, herring, grouper, monkfish, roughy, tilapia, catfish, marlin, tuna, bass, swordfish, mussels and scallops. Other potential ingredients are vegetables and fruits that might or might not be dried including, but not limited to: potatoes, beets, beet pult, carrots, beans, broccoli, banana, apples, celery, tomatoes, oranges, peas, cranberry, yam, grapes, blueberries, melon, cauliflower, onion, mushroom, lime, lemon, asparagus, cucumber, peaches, parsley, pineapple, watermelon, strawberries, raspberry, pickles, artichoke, zucchini, jelly, apricot, pineapple, grapefruit, and figs. Additional ingredients not as easily categorized might include, but are not limited to, the following miscellaneous items: peanut butter (creamy or crunchy), cereal based food, cheese, soy protein, catnip (and other herbs desirable to animals), caramel, garlic, lemon juice, cream, raisins, pecans, flax seed, textured vegetable protein, bulgur coconut, and marshmallow. Moreover, the product might include flavorings such as natural flavors, smoke flavor, bone flavoring, and barbeque flavoring.

It should be understood that other ingredients known to those of skill in the art are contemplated as within the scope of the invention. Such ingredients could include a wide variety of other foods known to be digestible by animals or pets. Some foods, such as chocolate, are known to be harmful to certain animals, such as dogs. Such a food, however, might find use in a treat for a different animal not susceptible to such an adverse reaction. It should also be understood that the edible treat might consist of one of the above described ingredients by itself and/or in combination with other ingredients in the above paragraph.

Having generically described in part at least some of the features of the present invention, the production of one preferred commercial embodiment will now be described. In one preferred embodiment, production of the treat involves rolling one or more of the ingredients to the consistency of a dough (as an example, in one embodiment the dough ingredients might include flour, water, salt, sugar, and margarine or butter) into flat sheets of desired thickness. This desired thickness is preferably the actual wall thickness of the treat prior to cooking. It should be understood that it is contemplated as within the scope of the invention that one or more embodiments might not be cooked. Such uncooked dough, however, would preferably include various preservatives in addition to being air dried to give it some rigidity. The flat sheets are then cut into long strips of dough. These long strips are then cut into the desired length of treat. The exterior of the treat is then preferably wrapped around a dowel rod to assist in providing a consistent interior shape of the treat.

The consumable treat is then preferably cooked at a temperature in the range of 325 to 475 degrees Fahrenheit (preferably in an air mixture oven) for approximately 18 to 45 minutes. The treats are then cooled at room temperature. After cooling, a filler or interior bed is injected or otherwise positioned within the interior cavity or pouch of the treat. The filler or interior bed preferably includes, but is not limited to one or more, or some combination of the following: peanut butter, cheese, beef, chicken, fish, horsemeat, lamb or other creamy fillings or mixtures of the same that are preferably easily digested by an animal and/or pet. In one particularly preferred embodiment the interior bed includes peanut butter or cheese or both. It should be understood that the peanut butter may be creamy or crunchy. Moreover, the use of crunchy peanut butter (i.e. with some solid peanut chunks therein) could provide an additional mechanism to disguise the presence of the medication (later inserted into the interior bed in the pouch) from the animal. It should further be understood that these preferred edible materials for the interior bed do not exclude the possibility of instead using one or more ingredients described in a previous paragraph.

It should also be understood that the exterior surface of the dowel rod may possess a shape other than cylindrical. That shape may be an irregular shape that repeats itself along the length of the dowel rod at intervals that substantially correspond to the desired length of the consumable treat. For example, the dowel rod might include one or more recesses of a size greater than a medication. Thus, the exterior surface of the treat might include recesses into which a sticky and/or filler material could be injected or otherwise placed. A medication could then be inserted into the recesses. Alternatively, the dowel rod could include one or more protrusions. Thus, the interior pouch of the treat could have recesses therein to which it might be possible to wedge the medication to further anchor the medication and prevent it from being separated from the treat. At present, however, for ease of manufacturing the treat preferably includes a substantially smooth interior surface. It should be understood that it is contemplated as within the scope of the invention that the exterior of the dowel rod could instead, for example, resemble a thickly threaded screw.

It should be understood that it is also contemplated as within the scope of the invention that various embodiments of the present invention might include automated machines being used in the production process. Baking trays might include a bottom tray having one or more recesses defined therein in the shape of the treat and a top tray shaped into a rod (or a plurality of rod-like protrusions) sized to fit into a corresponding cavity or recesses defined in the bottom tray. After placing the substance that will consist of the exterior of the treat into the bottom tray, the top tray is then inserted into the bottom tray. The exterior substance then molds around the rod of the exterior tray forming the size and shape of the treat. Both trays are then preferably cooked together while substantially adjacent one another for approximately 18 to 45 minutes at a temperature in the range of 325 to 475 degrees Fahrenheit. Note that the shape may be formed via this process even when the treat is not cooked as, for example, when prepared with a preservative. Another automated process might include an exterior “dough” wrapped around a rod and baked (or not baked based on the preservative associated with the product). After baking, the cooked “dough” is cut to form a closed end, and a second cut is made to form an open end. As will be discussed in further detail later, the manufacturing processes discussed herein may be automated in a variety of ways, as with the use of baking trays and/or an automated spout for dispensing any interior bed or filler material into the treat. To cook these treats a wide variety of different ovens might be used. They include but are not limited to: commercial, microwave, fan oven, multi-function oven, convection oven, gas, electric, confection, conveyor, cooking oven, fryers, industrial oven, conventional oven or custom made oven.

To further illustrate one preferred embodiment, the following description of the manufacture of approximately 150 consumable treats is provided. The “dough” for a preferably “crunchy” exterior of the consumable treat is preferably manufactured from the following ingredients: (1) four cups of flour (the flour might be whole wheat flour, organic whole wheat flour, soy flour, organic soy flour, rice flour, etc.); (2) ¼ cup of melted butter (or margarine); (3) one teaspoon of salt or similar preservative; (4) one tablespoon of sugar or similar preservative; and, (5) ¼-cup warm water. The sugar and salt are dissolved in the water. The flour and butter are then added and the result is mixed and/or blended to achieve the desired consistency (that is preferably somewhat moist).

When manufacturing by hand, the “dough” is rolled or otherwise flattened into sheets to the desired thickness of the edible treats. The sheets are then cut into squares. The squares are then rolled around a dowel rod to form the desired shape of the treat. As previously noted, the dowel rod, while preferably substantially cylindrical, can instead be a wide variety of shapes and/or forms. The “dough” wrapped dowel rod is then preferably cooked on a pan at about 375 degrees Fahrenheit for forty-five minutes. The treats are then allowed to cool to room temperature and preferably dried to remove any remaining moisture from the treat. The dowel rod is then removed and the filling is injected, dispensed or otherwise added to the interior cavity of the treat.

Alternatively, manufacturing might be accomplished using an automated process that includes, for example, one or more trays. In this embodiment a dough roller cuts the dough into the desired quantity necessary to make up the exterior shell of each treat. Each resulting quantity or ball of dough is positioned into one or more recesses defined in a bottom tray. The protrusions of a top tray are then inserted into the corresponding recesses of the bottom tray, the two together shaping the dough into the desired exterior surface of the treat. The top and bottom trays and dough therein are cooked together at about 375 degrees Fahrenheit for approximately twenty minutes. The treats are preferably immediately removed from the trays. The treats are then allowed to cool to room temperature and preferably dried to remove any remaining moisture from the treat. The removal, cooling and drying steps will preferably occur in an assembly line fashion. In an automated process the filler is preferably then dispensed into the pouch of the treat by a machine, preferably an automated spout.

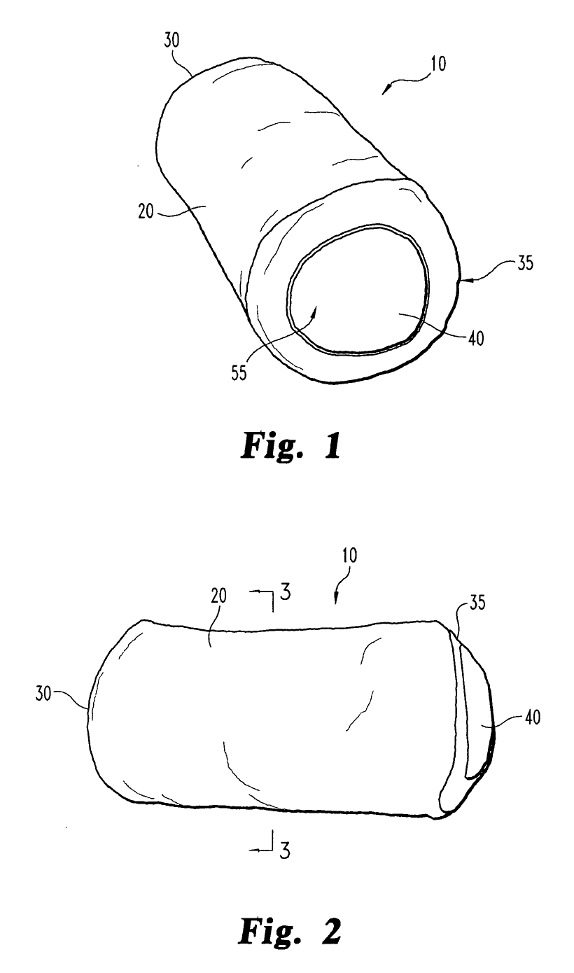

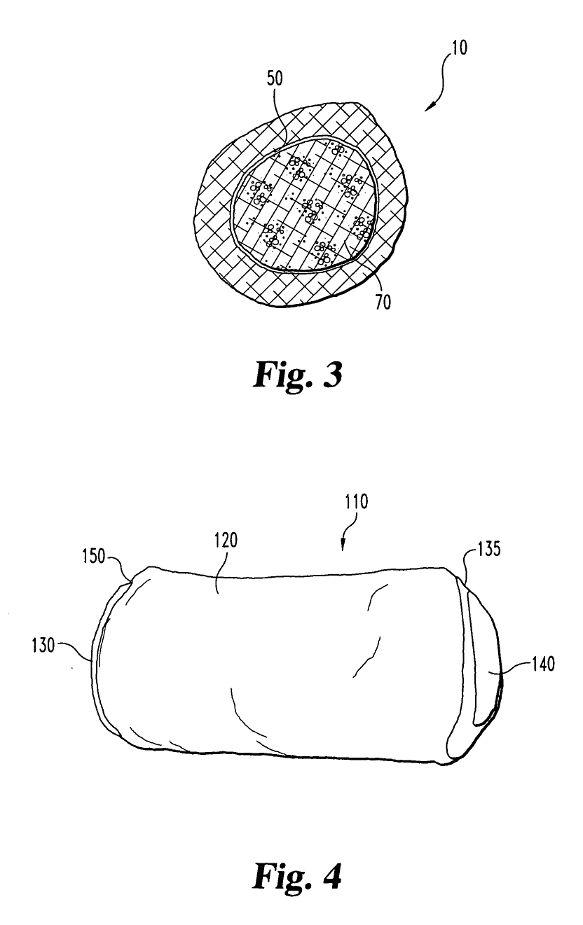

Referring now to FIGS. 1-3, one preferred embodiment of the present invention is illustrated. As illustrated, the treat 10 has a substantially cylindrical shape with an exterior surface 20 that is preferably closed on one end 30. At the other end 35, the exterior surface 20 of the treat 10 defines at least one opening 40 that connects the exterior surface 20 to an interior surface 50. The interior surface 50 defines an internal cavity referred to herein as pouch 55.

The exterior surface 20 of the treat 10 preferably comprises ingredients that (certainly after any baking) will be rigid enough to retain its shape during injection or insertion of, for example, peanut butter. But, naturally, the exterior surface 20 is intended to give in to the bite of an animal's teeth. Thus, it should be understood that in some embodiments of the present invention, the ingredients might preferably be selected based on the bite strengths of the animal or pet to which the treat is being administered. The exterior surface 20 is preferably only open on one end 30 to reduce and/or minimize the likelihood of the medication (not illustrated) falling out of the other end 35 of treat 10. In one preferred embodiment the single opening 40 permits access to pouch 55. Pouch 55 possesses sufficient volume to receive the material making up the interior bed 70 and receive the medication in the form of, for example, a liquid or pill. It should be understood that it is contemplated as within the scope of the invention that interior bed 70 may only partially fill the pouch 55. Thus, insertion of the medication by the pet or animal owner will preferably not displace a substantial amount of interior bed 70 from pouch 55. Alternatively, the interior bed 70 may substantially fill pouch 55. Thus, insertion of medication by the pet or animal owner will displace some amount of interior bed 70 from pouch 55.

The interior bed 70 preferably comprises an animal edible material that is softer than the material making up the exterior surface 20 of the treat 10. Such animal edible materials are known to those of skill in the art, it being understood that taste preferences are likely to vary from animal to animal. Examples include, but are not limited to, the previously mentioned meat, peanut butter, cheese or other creamy fillings or mixtures of the same easily digested by an animal. It should be understood that it is contemplated as within the scope of the invention that the interior bed 70 might comprise one or more of the list of ingredients set forth in a previous paragraph. Moreover, the selection of the ingredients might be tailored to the particular needs and risks associated with selected animals. For example, as previously noted, chocolate can be harmful to dogs and its selection as an ingredient for a treat generic to all animals or pets is thus precluded. However, for a treat designated for use only in a smaller class of animals or pets, chocolate might find use as an ingredient. It should further be understood that the thickness of the exterior surface 20 of the treat 10 is preferably such that it is easy for the animal's teeth to crush through the treat 10. Yet the thickness of exterior surface 20 also preferably allows for maximum volume for the pouch 55 that will receive the interior bed 70 and medication.

With reference to FIG. 4 there is illustrated another embodiment of the present invention. As illustrated, the treat 110 has a substantially cylindrical shape with an exterior surface 120 that is open on end 130 and at end 135. The exterior surface 120 of the treat 110 defines opening 140 at end 135 and opening 130 at end 150. The openings connect the exterior surface 120 to an interior surface (not illustrated). The interior surface defines an internal cavity referred to herein as pouch 155.

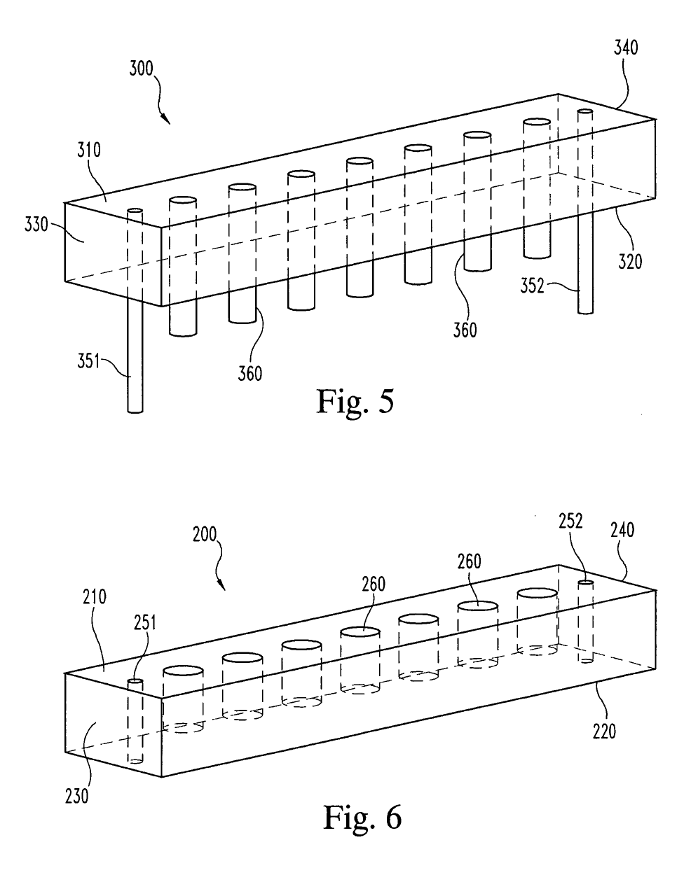

Referring now to FIGS. 5-6, there is illustrated an embodiment of the top and bottom trays as were previously discussed for use in an automated process. Bottom tray 200 extends between an upper surface 210 and a lower surface 220. Bottom tray 200 also extends between a first end 230 and a second end 240. In one embodiment, the length of bottom tray between first end 230 and second end 240 is approximately twelve inches. Top tray 300 similarly extends between an upper surface 310 and a lower surface 320. Top tray 300 also extends between a first end 330 and a second end 340. In one embodiment, the length of the corresponding top tray between first end 330 and second end 340 is also approximately twelve inches. Bottom tray 200 includes first and second pin holes 251 and 252 for receiving corresponding pins 351 and 352 that extend from the lower surface 320 of top tray 300. The pins 351 and 352 of top trap 300 are illustrated as being sufficiently long that the lower surface 320 of top tray 300 would not be in direct contact with the upper surface 210 of bottom tray 200. It should be understood that it is contemplated as within the scope of the invention that the length of the pins 351 and 352 may vary, and the bottom surface 320 of top tray 300 may be further away from the top surface 210 of bottom tray 200, or may be in direct contact with it.

The bottom tray 200 includes a plurality of recesses 260 extending from the upper surface 210 toward the lower surface 220. The recesses 260 are preferably substantially cylindrical. In embodiments of the invention that include an opening at only one end of the treat, the recesses 260 preferably do not extend all the way to the lower surface 220 of the bottom tray 200. In forming embodiments of the invention that include an opening at both ends of the treat the recesses 260 preferably do extend all the way to the lower surface 220 of the bottom tray 200. In one preferred embodiment of the invention the substantially cylindrical recesses 260 have a radial diameter of approximately 0.75 inches and a depth of approximately 1.5 inches. In this preferred embodiment the bottom tray 200 preferably is 2 inches deep from the upper surface 210 toward the lower surface 220.

The top tray 300 includes a plurality of preferably rod-like protrusions 360 extending from the lower surface 320 and sized to be received in the corresponding recesses 260 of bottom tray 200. In one preferred embodiment the protrusions 360 are substantially cylindrical with a radial diameter of approximately 0.437 inches and length of 1.75 inches. In this preferred embodiment the pins 351 and 352 are longer than the pin holes 251 and 252. Thus, the entire length of the protrusions 360 will not extend into the recesses 260. It should be understood, however, that it is contemplated as within the scope of the invention that the protrusions 360 can extend through the entire length of the recesses 260 and might even extend past the lower surface 220 of bottom tray 200. This would likely be preferred in situations wherein the treat was being manufactured to have openings at both ends. It should also be understood that the recesses 260 of bottom tray 200 may be of different diameters and/or lengths so that treats of varying dimensions may be produced at the same time. In such an embodiment the corresponding protrusions 360 of top tray 300 will also vary in diameter and/or length.

It should be understood that it is contemplated as within the scope of the invention that various natural and/or artificial flavorings might be added to the consumable treat. Such flavorings may be tailored to the particular animal or pet for which the treat is intended. Such flavorings may relate to taste, or to the scent of the treat, or both. For example, a standard “dough” as previously described could be used in the manufacture of the (preferably substantially crunchy) exterior of the treat to provide for a lengthy shelf life. Various flavorings, seasonings, or spices could be added to make that “dough” taste like meat or chicken. Similar flavorings, seasonings, or spices could be applied to the interior filling of the treat as well. As a non-limiting example, it might be the case that a given animal or pet does not like cheese (such as might be used in the filling placed in the internal compartment of the treat). That same animal or pet might like the taste (or smell) of fish, such as cod, but does not object to the consistency of the cheese (or mixture including cheese) used in one embodiment of the present invention. Various flavorings, seasonings, and/or spices could be added to the filling to make it taste and/or smell like cod. It should be understood that it is contemplated as within the scope of the invention that such flavorings could be applied to a number of the ingredients in the dough or filler. Furthermore, each such ingredient could be flavored as desired to imitate the smell and/or taste of some other ingredient considered more desirable to the animal or pet.

It should be understood that the total size of the consumable treat 10 will naturally vary based on the size of the animal or pet (the medication often being correspondingly larger for larger animals and/or pets). Thus the treat 10 can preferably be consumed without the animal or pet setting the treat on the ground. However, it should be clear that, at least in some embodiments, if the treat is set on the ground by the animal or pet, the medication will preferably adhere to the materials and/or ingredients of the interior bed, so that the medication stays with (preferably within) the treat. Dimensions of the consumable treat of the present invention may also be varied based on the size, dosage, or amount of the medication to be administered. The size of the treat is preferably tailored at least in part to correspond to the size of the medication. Thus, the chances of the medication not being consumed are reduced significantly. It is further understood that consumers may apply one or numerous pills inside each consumable treat for application. Thus, larger animals will be able to consume larger treats and more than one pill in a setting whereas smaller animals will most likely only be able to consume one treat and one pill at a time.

Animal and pet owners might also use the consumable treat of the present invention as a regular treat as well. By administering the consumable treats of the present invention to animals on a regular basis with or without medication, animal owners may condition their animal to ingesting the treat as a snack on a regular basis. Thus, the animal will be even less suspecting of a pill or liquid when it is time to administer medication. However, cost constraints of commercial embodiments presently under consideration are likely to preclude this method of conditioning by many animal owners, at least in the near future. Moreover, present channels of trade will likely include marketing through veterinarians, instead of pet stores. This aspect further weighs against such a conditioning mechanism being implemented in the near future. However, it should be understood that while not being considered for use in the immediate future, such usage is nonetheless possible and is contemplated as within the scope of the invention.

The present invention assists in transforming a stressful, strenuous situation on an animal or pet and its owner into a positive, healthy event for both. The medication is thus preferably administered in a playful atmosphere for both. The invention also preferably results in increased animal or pet owner compliance in completing the prescribed full course of treatment, instead of stopping short due to frustration in the implementation of different, more difficult, and/or unhealthy methods. The present invention also reduces unnecessary expenditures on medication that the animal or pet fails to properly or fully consume.

While the invention has been illustrated and described in detail in the drawings and foregoing description, the same is to be considered illustrative and not restrictive in character, it being understood that only the preferred embodiment has been shown and described and that all changes and modifications that come within the spirit of the invention are desired to be protected.

1. A treat for administering medication to an animal or pet, comprising:
an at least partially hollow edible baked material extending between a first end and a second end, the baked material including at least a first opening at the first end and a second opening at the second end, the first opening being connected to the second opening by the inner surface of the baked material that defines an internal compartment therein; and,
an interior bed positioned substantially within the internal compartment, the interior bed including one or more edible ingredients having adhesive properties for retaining the medication at least partially within the internal compartment.

2. The treat of claim 1, wherein the interior bed includes peanut butter.

3. The treat of claim 2, wherein the interior bed further includes some cheese.

4. The treat of claim 2, wherein the peanut butter is a crunchy peanut butter.

5. The treat of claim 1, wherein the baked material is rigid and defines a substantially cylindrical wall, and the first opening and the second opening are substantially circular.

6. The treat of claim 5, wherein the first opening and the second opening have different sizes.

7. An animal or pet treat for administering medication, comprising
an edible substantially rigid baked dough having a wall with an exterior surface and an interior surface extending between a first end and a second end, the second end of the exterior surface defining at least one opening connecting the interior surface and the exterior surface; and,
a sticky edible material that at least partially fills a pouch within the treat, the pouch being defined by the interior surface of the wall.

8. The treat of claim 7, wherein the sticky edible material includes peanut butter.

9. The treat of claim 7, wherein the wall of the baked dough defines at least two openings that have different sizes.

10. The treat of claim 7, wherein the wall of the baked dough is shaped so that the treat is substantially cylindrical.

11. The treat of claim 10, wherein the substantially cylindrical treat extends between a first end and a second end, the wall of the baked dough defining a first opening at the first end and a second opening at the second end.

12. The treat of claim 7, wherein the sticky edible material includes a meat.

13. The treat of claim 7, wherein the sticky edible material includes catnip.

14. The treat of claim 13, wherein the treat has only a single opening.

15. A treat for administering medication to an animal or pet, comprising:
an at least partially hollow edible material having an exterior surface and an interior surface, the exterior surface defining at least two separate openings through which a pocket defined by the interior surface can be accessed, and wherein at least two of the openings are of different sizes; and,
an interior bed substantially positioned within the pocket, the interior bed including one or more edible ingredients having adhesive properties for retaining the medication at least partially within the pocket.

16. The treat of claim 15, wherein the interior bed includes a crunchy peanut butter.

17. The treat of claim 16, wherein the interior bed further includes a cheese.

18. The treat of claim 15, wherein the exterior surface of the edible material is shaped such that the treat is substantially cylindrical.

19. The treat of claim 18, wherein the edible material is a substantially rigid baked dough.

20. The treat of claim 19, wherein the interior surface is substantially smooth, and wherein the interior bed only partially fills the pocket of the treat, and the interior bed includes a crunchy peanut butter.
